(19) United States
(12) Patent Application Publication
(10) Pub. No.: US 2026/0229546 A1
(43) Pub. Date: Aug. 6, 2026

(54) CURRENT COLLECTOR FOR BIPOLAR ELECTRODE AND RECYCLING METHOD OF CURRENT COLLECTOR FOR BIPOLAR ELECTRODE

(71) Applicant: TOYOTA JIDOSHA KABUSHIKI KAISHA, Toyota-shi (JP)

(72) Inventors: Satoru CHIMURA, Toyota-shi (JP); Yusuke KINTSU, Miyoshi-shi (JP); Hirokazu TAKEUCHI, Toyota-shi (JP); Takahiko NAKANO, Nagoya-shi (JP)

(73) Assignee: TOYOTA JIDOSHA KABUSHIKI KAISHA, Toyota-shi (JP)

(21) Appl. No.: 19/407,783

(22) Filed: Dec. 3, 2025

(30) Foreign Application Priority Data
Feb. 3, 2025 (JP) 2025-015923

(51) Int. Cl. H01M 4/66; H01M 4/02; H01M 10/54

(52) U.S. Cl. CPC H01M 4/667; H01M 4/661; H01M 10/54; H01M 2004/029

(57) ABSTRACT

A current collector for a bipolar electrode includes a first metal foil provided on one face, a second metal foil that is of a different kind from the first metal foil and that is provided on another face, and a conductive adhesive layer interposed between the first metal foil and the second metal foil, so as to bond the two together, in which an outer edge of the conductive adhesive layer is a dehydrating adhesive layer that undergoes a dehydration reaction when heated to 100° C. or higher.

### CROSS-REFERENCE TO RELATED APPLICATION

This application claims priority to Japanese Patent Application No. 2025-015923 filed on Feb. 3, 2025. The disclosure of the above-identified application, including the specification, drawings, and claims, is incorporated by reference herein in its entirety.

### BACKGROUND

### 1. Technical Field

The present disclosure relates to a current collector for a bipolar electrode, and to a recycling method of the current collector for a bipolar electrode.

### 2. Description of Related Art

Japanese Unexamined Patent Application Publication No. 2022-075283 (JP 2022-075283 A) discloses a current collector for a bipolar electrode that uses an Al foil on a cathode side and a Cu foil on an anode side.

### SUMMARY

When recycling a current collector to which different types of metal are bonded, as disclosed in JP 2022-075283 A, it is necessary to peel and to separate these different types of metal. However, the different types of metal that make up the current collector are configured having the same area, there is no pinching allowance for peeling the two pieces apart, which may make separation difficult.

The present disclosure has been made in view of the above circumstances, and an object thereof is to provide a current collector for a bipolar electrode that can facilitate separation of different types of metal that make up the current collector and improve recyclability, and a recycling method of the current collector for a bipolar electrode.

A current collector for a bipolar electrode, according to the present disclosure, includes a first metal foil that is provided on one face, a second metal foil that is of a different kind from the first metal foil and that is provided on another face, and a conductive adhesive layer that is interposed between the first metal foil and the second metal foil, so as to bond the two together, in which an outer edge of the conductive adhesive layer is a dehydrating adhesive layer that undergoes a dehydration reaction when heated to 100° C. or higher.

A recycling method of a current collector for a bipolar electrode, according to the present disclosure, includes heating the current collector that is described above to 100° C. or higher, such that the dehydrating adhesive layer provided on the outer edge of the conductive adhesive layer interposed between the first metal foil and the second metal foil is evaporated or is expanded, creating a gap between the first metal foil and the second metal foil.

According to the present disclosure, separation of different types of metal making up a current collector is facilitated, and recyclability can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a cross-sectional view illustrating a configuration of a current collector for a bipolar electrode, according to an embodiment;

FIG. 1B is a plan view illustrating the configuration of the current collector for a bipolar electrode, according to the embodiment;

FIG. 2A is a cross-sectional view for describing a recycling method of the current collector for a bipolar electrode, according to the embodiment;

FIG. 2B is a cross-sectional view for describing the recycling method of the current collector for a bipolar electrode, according to the embodiment;

FIG. 3A is a cross-sectional view illustrating a configuration of a conventional current collector for a bipolar electrode; and

FIG. 3B is a plan view illustrating the configuration of the conventional current collector for a bipolar electrode.

### DETAILED DESCRIPTION OF EMBODIMENTS

A current collector for a bipolar electrode, and a recycling method for the current collector for a bipolar electrode, according to an embodiment of the present disclosure, will be described with reference to the drawings. Note that components in the following embodiment include components that are replaceable and easy for persons skilled in the art or components that are substantially identical.

### Current Collector for Bipolar Electrode

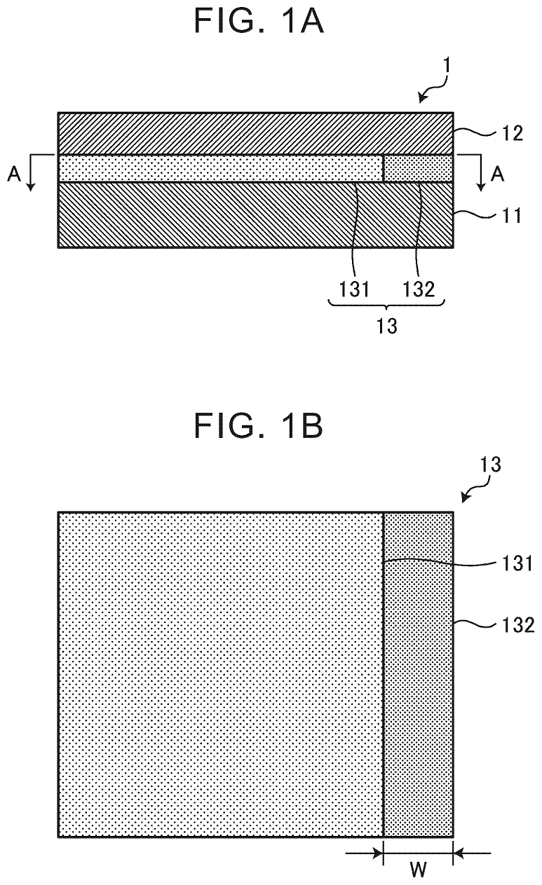

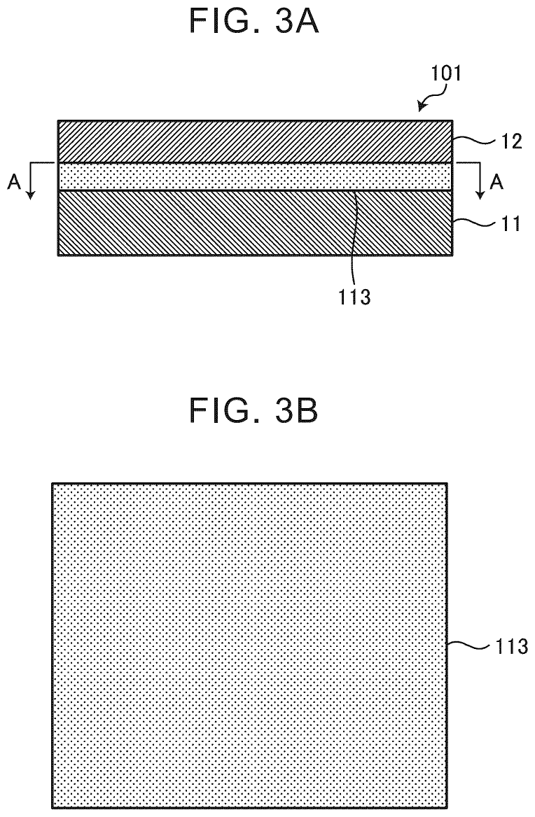

The current collector for a bipolar electrode, according to the embodiment, will be described with reference to FIGS. 1A, 1B, 3A, and 3B. The current collector for a bipolar electrode according to the embodiment is a component that makes up a power storage module that is installed in, for example, a vehicle. Vehicles in which this power storage module is installed include, for example, hybrid electric vehicles (HEVs), plug-in hybrid electric vehicles (PHEVs), battery electric vehicles (BEVs), and so forth.

FIG. 1A is a cross-sectional view of a current collector 1 for a bipolar electrode, according to the embodiment, as viewed from the side. Also, FIG. 1B is a plan view of a conductive adhesive layer 13 of the current collector 1 as viewed from a position A-A in FIG. 1A. The current collector 1 includes an Al foil 11, a Cu foil 12, and the conductive adhesive layer 13.

The Al foil (aluminum foil) 11 is made of aluminum. Also, the Al foil 11 is provided on one face of the current collector 1. The Cu foil (copper foil) 12 is made of copper. Also, the Cu foil 12 is provided on the other face of the current collector 1, which is the face opposite to the one face thereof. Also, the Cu foil 12 is bonded to the Al foil 11 via the conductive adhesive layer 13.

The conductive adhesive layer 13 is interposed between the Al foil 11 and the Cu foil 12, to bond the two together. The conductive adhesive layer 13 is made of, for example, a conductive adhesive containing an adhesive and a conductive component. The adhesive agent is not limited in particular regarding components thereof, but can be made of a curable resin such as an olefin-based resin, an acrylic-based resin, or the like, for example. The conductive component is not limited in particular as long as the conductivity thereof is higher than that of the adhesive. Examples of the conductive components include metal particles, alloy particles such as aluminum-magnesium alloy or the like, particles obtained by coating metal oxide particles or metal particles with precious metals, particles obtained by coating non-conductive particles with precious metals, particles obtained by plating non-conductive particles with metal, carbon particles, and so forth.

Thus, the current collector 1 is made up of the Al foil 11 which is a first metal foil, the Cu foil 12 which is a second metal foil of a different type from the first metal foil, and the conductive adhesive layer 13 which bonds the two together.

Now, FIGS. 3A and 3B are diagrams illustrating a configuration of a current collector 101 according to conventional art. FIG. 3A is a cross-sectional view of the current collector 101 as viewed from the side. Also, FIG. 3B is a plan view of a conductive adhesive layer 113 of the current collector 101 as viewed from a position A-A in FIG. 3A. The current collector 101 includes the Al foil 11, the Cu foil 12, and the conductive adhesive layer 113.

As illustrated in FIG. 3A, the current collector 101 is made of the Al foil 11 and the Cu foil 12 that are configured having the same area. Accordingly, when recycling the current collector 101, there is no pinching allowance for peeling the Al foil 11 and the Cu foil 12 apart, which causes a problem of poor recyclability.

Accordingly, as illustrated in FIGS. 1A and 1B, in the current collector 1 according to the embodiment a part of the conductive adhesive layer 13 is configured as a dehydrating adhesive layer 132 that undergoes a dehydration reaction when heated to 100° C. or higher. A specific configuration of the conductive adhesive layer 13 will be described below.

The conductive adhesive layer 13 is made up of a non-dehydrating adhesive layer 131 and the dehydrating adhesive layer 132. The non-dehydrating adhesive layer 131 is provided on the conductive adhesive layer 13 except for an outer edge portion thereof. Also, the non-dehydrating adhesive layer 131 is made of an adhesive that does not undergo a dehydration reaction when heated to 100° C. or higher.

The dehydrating adhesive layer 132 is provided on the outer edge of the conductive adhesive layer 13. Also, as illustrated in FIG. 1B, the dehydrating adhesive layer 132 is provided on just one side of the four sides of the outer edge of the conductive adhesive layer 13. Also, a width W of the dehydrating adhesive layer 132 is preferably at least 5 mm or more, and more preferably 10 mm or more.

Also, the dehydrating adhesive layer 132 is made of an adhesive that undergoes a dehydration reaction when heated to 100° C. or higher (e.g., a water-based adhesive). Examples of the water-based adhesives include water-based curable resins such as water-dispersed olefin-based resins, or the like.

### Recycling Method of Current Collector for Bipolar Electrode

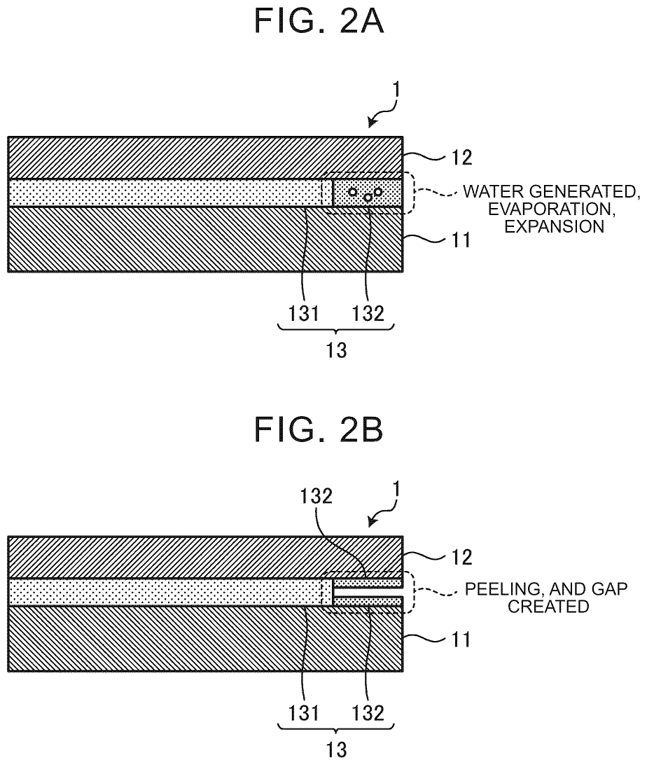

The recycling method of the current collector for a bipolar electrode according to the embodiment will be described with reference to FIGS. 2A and 2B.

In the recycling method for the current collector 1, as illustrated in FIG. 2A for example, the dehydrating adhesive layer 132 provided on the outer edge of the conductive adhesive layer 13 interposed between the Al foil 11 (first metal foil) and the Cu foil 12 (second metal foil) is heated to 100° C. or higher. At this time, heating may be performed by targeting only the dehydrating adhesive layer 132, or the current collector 1 in its entirety may be heated as necessary.

Heating the dehydrating adhesive layer 132 in this manner causes the dehydrating adhesive layer 132 to vaporize or expand. Vaporizing or expanding the dehydrating adhesive layer 132 then causes the Al foil 11 and the Cu foil 12 to be peeled apart from each other, creating a gap therebetween, as illustrated in FIG. 2B, for example.

In the recycling method for the current collector 1, the dehydration reaction occurs during heating as illustrated in FIG. 2A, causing just one side of the four sides of the current collector 1 to vaporize or to expand, thereby generating the gap between the Al foil 11 and the Cu foil 12, and consequently forming a pinching allowance for peeling the two apart. In the recycling method for the current collector 1, the Al foil 11 and the Cu foil 12 are separated from each other with the gap in the dehydrating adhesive layer 132 as a starting point.

In the recycling method for the current collector 1, the current collector only needs to be heated to 100° C. or higher, at which point the dehydration reaction and evaporation of water occur, which can reduce costs as compared to conventional recycling methods, such as heating the conductive adhesive layer to a high temperature of 400° C. or higher, for decomposition thereof, for example. Further, in the recycling method for the current collector 1, providing the dehydrating adhesive layer 132, which undergoes dehydration, on just one side of the outer edge of the conductive adhesive layer 13 enables effects to be minimized even in an event of dehydration occurring during operation of the power storage module, for example.

According to the current collector for a bipolar electrode according to the embodiment described above, different types of metal making up the current collector 1 can be easily separated, thereby improving recyclability. Also, according to the recycling method for the current collector for a bipolar electrode according to the embodiment, heating the current collector 1 to 100° C. or higher, just the dehydrating adhesive layer 132 provided on one side of the current collector 1 is caused to vaporize or expand due to the dehydration reaction, whereby the gap can be formed between the different types of metal (Al foil 11 and Cu foil 12). This enables formation of the pinching allowance when peeling the Al foil 11 and the Cu foil 12, facilitating separation of the two, and improving recyclability.

Further effects and modifications can easily be derived by persons skilled in the art. Accordingly, broader aspects of the present disclosure are not limited to the specific details and the representative embodiment expressed and described above. Accordingly, various modifications can be made without departing from the spirit or scope of the general concept of the disclosure as defined by the appended claims and their equivalents.

What is claimed is:

1. A current collector for a bipolar electrode, the current collector comprising:
a first metal foil that is provided on one face;
a second metal foil that is of a different kind from the first metal foil and that is provided on another face; and
a conductive adhesive layer interposed between the first metal foil and the second metal foil, so as to bond the two together, wherein
an outer edge of the conductive adhesive layer is a dehydrating adhesive layer that undergoes a dehydration reaction when heated to 100° C. or higher.

2. A recycling method of a current collector for a bipolar electrode, the recycling method comprising:
heating the current collector according to claim 1 to 100° C. or higher, such that the dehydrating adhesive layer provided on the outer edge of the conductive adhesive layer interposed between the first metal foil and the second metal foil is evaporated or is expanded, creating a gap between the first metal foil and the second metal foil.
